(19) United States
(12) Patent Application Publication
(10) Pub. No.: US 2024/0331124 A1
(43) Pub. Date: Oct. 3, 2024

(54) INFORMATION PROCESSING SYSTEM, INFORMATION PROCESSING METHOD, AND INFORMATION PROCESSING APPARATUS

(71) Applicant: NEC Corporation, Minato-ku, Tokyo (JP)

(72) Inventors: Koichi NIHEI, Tokyo (JP); Yoshifumi Onishi, Tokyo (JP); Takanori Iwai, Tokyo (JP)

(73) Assignee: NEC Corporation, Minato-ku, Tokyo (JP)

(21) Appl. No.: 18/580,204

(22) PCT Filed: Sep. 30, 2021
(86) PCT No.: PCT/JP2021/036245

§ 371 Date: Jan. 18, 2024

(51) Int. Cl. G06T 7/00

(52) U.S. Cl. CPC G06T 7/0002; G06T 2207/30168

(57) ABSTRACT

An information processing system (1) includes: specifying means (12) for specifying, in accordance with an analysis result based on a coded and distributed image, an image quality of an area including a specific part in the distributed image; and control means (13) for performing control for distributing the image in which the image quality of the area including the specific part is the specified image quality.

### TECHNICAL FIELD

The present disclosure relates to an information processing system, an information processing method, and an information processing apparatus.

### BACKGROUND ART

Techniques for performing various kinds of analysis (medical examination, diagnosis, or testing) based on an image have been known. With regard to this technique, Patent Literature 1 describes an invention that uses a trained model, which has learned the compression rate of image data generated by a device such as X-ray CT, to maintain image quality of decompressed images at a desired level. Patent Literature 1 further describes that the degree of compression is increased for areas where observation is unnecessary.

Patent Literature 2 describes an invention in which a remote desktop that transfers screen data resulting from processing to a client determines an operation state of the client and adjusts the quality of medical image data based on a result of the determination and an effective bandwidth of a network.

### CITATION LIST

### Patent Literature

Patent Literature 1: Japanese Unexamined Patent Application Publication No. 2020-177333
Patent Literature 2: Japanese Unexamined Patent Application Publication No. 2012-003447

### SUMMARY OF INVENTION

### Technical Problem

However, in Patent Literature 1, actions to be taken to perform an analysis based on an image distributed via a network have not been studied. Moreover, in Patent Literature 2, actions to be taken when an analysis based on an image is difficult have not been studied. Therefore, according to the technique disclosed in Patent Literature 1 or 2, for example, there may be a case where an analysis based on an image (including both a still image and a moving image (a video image)) distributed via a network cannot be appropriately performed.

In view of the aforementioned problem, an object of the present disclosure is to provide a technique for appropriately performing an analysis based on an image distributed via a network.

### Solution to Problem

In a first aspect according to the present disclosure, an information processing system includes: specifying means for specifying, in accordance with an analysis result based on a coded and distributed image, an image quality of an area including a specific part in the distributed image; and control means for performing control for distributing the image in which the image quality of the area including the specific part is the specified image quality.

In a second aspect according to the present disclosure, an information processing method includes: processing for specifying, in accordance with an analysis result based on a coded and distributed image, an image quality of an area including a specific part in the distributed image; and processing performing control for distributing the image in which the image quality of the area including the specific part is the specified image quality.

In a third aspect according to the present disclosure, an information processing apparatus includes: specifying means for specifying, in accordance with an analysis result based on a coded and distributed image, an image quality of an area including a specific part in the distributed image; and control means for performing control for distributing the image in which the image quality of the area including the specific part is the specified image quality.

### Advantageous Effects of Invention

According to one aspect, it is possible to appropriately perform an analysis based on an image distributed via a network.

### BRIEF DESCRIPTION OF DRAWINGS

FIG. 1 is a diagram showing one example of a configuration of an information processing apparatus according to an example embodiment;

FIG. 2 is a diagram showing one example of a configuration of the information processing apparatus according to the example embodiment;

FIG. 3 is a diagram showing one example of a configuration of an information processing system according to an example embodiment;

FIG. 4 is a diagram showing an example of a hardware configuration of an information processing apparatus according to the example embodiment;

FIG. 5 is a sequence diagram showing one example of processes of the information processing system according to the example embodiment;

FIG. 6 is a diagram showing one example of an image quality change contents DB according to the example embodiment;

FIG. 7 is a diagram showing one example of an area of a specific part according to the example embodiment; and

FIG. 8 is a sequence diagram showing one example of the processes of the information processing system according to the example embodiment.

### EXAMPLE EMBODIMENT

### First Example Embodiment

Principles of the present disclosure are described with reference to several example embodiments. It should be understood that these example embodiments are set forth for purposes of illustration only and that those skilled in the art will assist in understanding and practicing the present disclosure without suggesting limitations on the scope of the present disclosure. The disclosure described herein may be implemented in various methods other than those described below.

In the following description and claims, unless otherwise defined, all technical and scientific terms used herein have the same meaning as commonly understood by one of those skilled in the art of technology to which the present disclosure belongs.

Hereinafter, example embodiments of the present disclosure will be described with reference to the drawings.

### <Configuration>

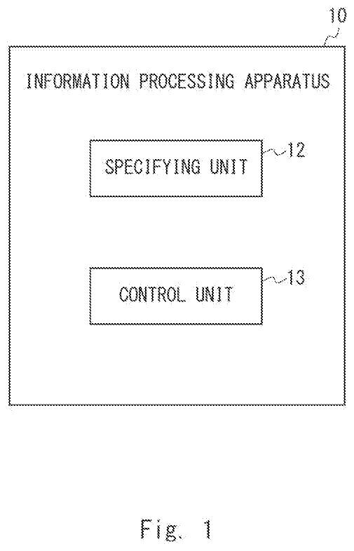

Referring to FIG. 1, a configuration of an information processing apparatus 10 according to an example embodiment will be described. FIG. 1 is a diagram showing one example of the configuration of the information processing apparatus 10 according to the example embodiment. The information processing apparatus 10 includes a specifying unit 12 and a control unit 13. These units may be implemented by cooperation of one or more programs installed in the information processing apparatus 10 and hardware such as a processor 101 and a memory 102 of the information processing apparatus 10.

The specifying unit 12 determines an image quality of an area of a specific part of an image, for example, in accordance with an analysis result based on a coded and distributed image. The specifying unit 12 receives (acquires) various kinds of information from a storage unit inside the information processing apparatus 10 or from an external apparatus. The specifying unit 12 executes various kinds of processes based on the image captured by the image-capturing apparatus 20 and distributed. For example, the specifying unit 12 may cause an analysis module or the like inside or outside the information processing apparatus 10 to execute an analysis (inspection or estimation) based on an area of a specific part of a subject in the image. For example, a heart rate may be analyzed based on an image of an area of the subject's face. When the analysis is performed by an external apparatus, the specifying unit 12 may transmit an image to the external apparatus and acquire an analysis result obtained by the external apparatus from the external apparatus.

The control unit 13 transmits (outputs) information based on the results of the determination made by the specifying unit 12 to each of processing units inside the information processing apparatus 10, or to an external apparatus. The control unit 13 transmits information (command) for distributing an image whose image quality of the area of the specific part is the image quality determined by the specifying unit 12. This command may include, for example, information indicating the area of the specific part and information indicating the image quality of the area of the specific part.

The information processing apparatus 10 may either be an apparatus to which the image captured by the image-capturing apparatus 20 and coded is distributed or an apparatus that has distributed the image captured by the image-capturing apparatus 20 and coded.

### <Processes>

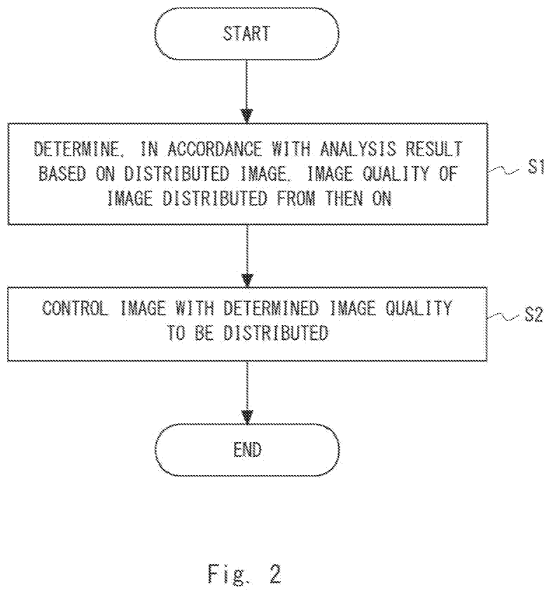

Referring next to FIG. 2, one example of processes in the information processing apparatus 10 according to the example embodiment will be described. FIG. 2 is a flowchart showing one example of the processes in the information processing apparatus 10 according to the example embodiment.

In Step S1, the specifying unit 12 determines, in accordance with an analysis result based on an area of a specific part of a subject with a first image quality in a first image captured by the image-capturing apparatus 20 and distributed via the network N, a second image quality of the area of the specific part in the second image captured by the image-capturing apparatus 20. Next, the control unit 13 controls the second image in which the image quality in the area of the specific part is the second image quality to be distributed (Step S2).

(Process example when information processing apparatus 10 is apparatus to which image is distributed)

When the information processing apparatus 10 is an apparatus to which an image is distributed, the specifying unit 12 may receive the image via the network N. Then, the specifying unit 12 may determine the image quality in accordance with the analysis result based on the image. Then, the control unit 13 may transmit, to the apparatus to which the image is distributed, a command for setting (changing) the quality of the image distributed from the apparatus to which the image is distributed to the above image quality.

(Process example when information processing apparatus 10 is apparatus that distributes image)

When the information processing apparatus 10 is an apparatus that distributes an image, the specifying unit 12 may receive the image from the image-capturing apparatus 20 built into the information processing apparatus 10 via an internal bus. Further, the specifying unit 12 may receive the image from an external (externally attached) image-capturing apparatus 20 connected to the information processing apparatus 10 by a cable or the like via an external bus (e.g., a Universal Serial Bus (USB) cable, a High-Definition Multimedia Interface (HDMI) (registered trademark) cable, or a Serial Digital Interface (SDI) cable). Then the specifying unit 12 may determine the image quality in accordance with the analysis result based on the coded image. The specifying unit 12 may then determine the image quality in accordance with the analysis result based on the image coded by a module or the like that performs coding processing in the information processing apparatus 10. The analysis based on the coded image may be performed by the information processing apparatus 10 or by the external apparatus. Then the control unit 13 may transmit, to a module that performs coding processing inside the information processing apparatus 10 or to the image-capturing apparatus 20, a command for setting (changing) the quality of the image distributed from the information processing apparatus 10 to the above image quality.

### <Hardware Configuration>

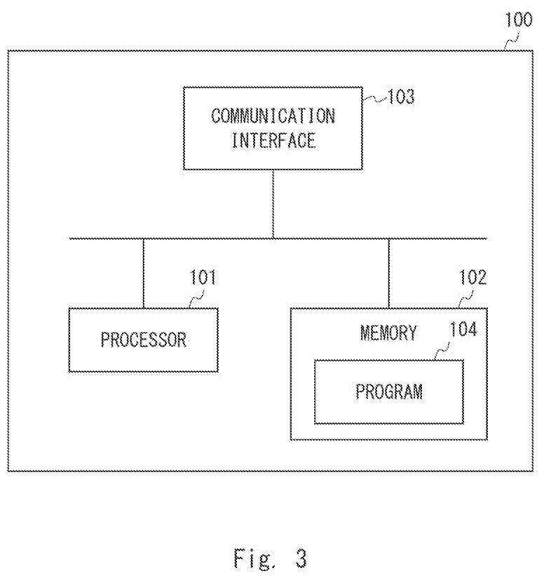

FIG. 3 is a diagram showing an example of a hardware configuration of the information processing apparatus 10 according to the example embodiment. In the example shown in FIG. 3, the information processing apparatus 10 (a computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by cooperation of the processor 101, the memory 102, and the like, the computer 100 performs at least a part of processing for the example embodiment of the present disclosure. The memory 102 may be of any type suitable for a local technical network. The memory 102 may be, by way of non-limiting example, a non-transitory computer readable storage medium. Further, the memory 102 may be implemented using any suitable data storage technology, such as semiconductor based memory devices, magnetic memory devices and systems, optical memory devices and systems, fixed memory and removable memory, as non-limiting examples. While only one memory 102 is shown in the computer 100, there may be several physically distinct memory modules in the computer 100. The processor 101 may be of any type. The processor 101 may include one or more of general purpose computers, special purpose computers, microprocessors, digital signal processors (DSPs) and processors based on multicore processor architecture, as non-limiting examples. The computer 100 may have multiple processors, such as an application specific integrated circuit chip that is slaved in time to a clock which synchronizes the main processor.

The example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method according to the present disclosure. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus. The program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The program can be stored and provided to a computer using any type of non-transitory computer readable media. Non-transitory computer readable media include any type of tangible storage media. Examples of non-transitory computer readable media include magnetic storage media, optical magnetic storage media, optical disc media, semiconductor memories, etc. The magnetic storage media include, for example, flexible disks, magnetic tapes, hard disk drives, etc. The optical magnetic storage media include, for example, magneto-optical disks. The optical disc media include, for example, a Blu-ray disc, a Compact Disc (CD)—Read Only Memory (ROM), CD-Recordable (R), CD-ReWritable (RW), etc. The semiconductor memories include, for example, solid state drive, mask ROM, Programmable ROM (PROM), Erasable PROM (EPROM), flash ROM, random access memory (RAM), etc. The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### <System Configuration>

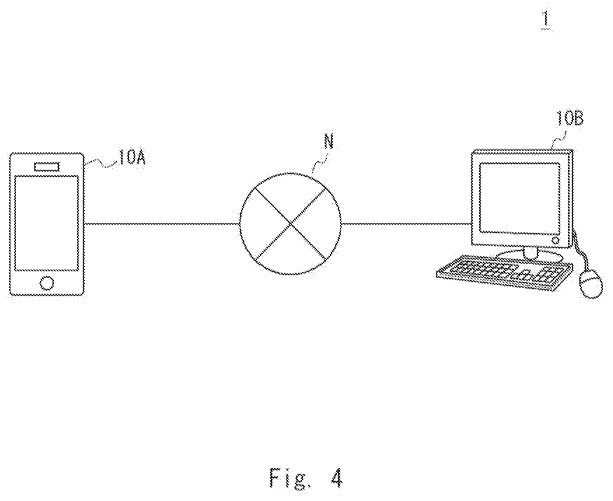

Referring next to FIG. 4, a configuration of an information processing system 1 according to an example embodiment will be described. FIG. 4 is a diagram showing a configuration example of the information processing system 1 according to the example embodiment. In the example of FIG. 4, the information processing system 1 includes an information processing apparatus 10A and an information processing apparatus 10B (hereinafter simply referred to as “information processing apparatus 10” when it is not necessary to distinguish between them). Note that the number of information processing apparatus 10A and information processing apparatus 10B are not limited to those shown in the example in FIG. 4.

Note that the technique according to the present disclosure may be used, for example, for measurement of biological information based on a patient's image in a video conference (a video call or an online medical examination) between a doctor and a patient (a human being or an animal). The technique according to the present disclosure may also be used, for example, for analysis (specification) of a person and analysis (estimation) of behavior based on images in a monitoring camera. The technique according to the present disclosure may also be used, for example, for analysis (testing) of a product based on images of a monitoring camera installed in a factory or a plant.

In the example shown in FIG. 4, the information processing apparatus 10A and the information processing apparatus 10B are connected to each other in such a way that they can communicate with each other via a network N. The network N includes, for example, the Internet, a mobile communication system, wireless Local Area Network (LAN), LAN, a short-range wireless communication such as Bluetooth (registered trademark) Low Energy (BLE), and the like. The mobile communication system includes, for example, the fifth generation mobile communication system (5G), the fourth generation mobile communication system (4G), the third generation mobile communication system (3G), and the like.

The information processing apparatus 10A may be, for example, an apparatus including a smartphone, a tablet, a personal computer or the like. The information processing apparatus 10A codes an image (including a still image and a moving image (a video image)) captured by a built-in or an external image-capturing apparatus 20 by any coding scheme and distributes the coded image to the information processing apparatus 10B via the network N. This coding scheme may include, for example, H.265/High Efficiency Video Coding (HEVC), AOMedia Video 1 (AV1), H.264/MPEG-4 Advanced Video Coding (AVC), and the like.

The information processing apparatus 10B may be, for example, an apparatus such as a personal computer, a server, a cloud, a smartphone, or a tablet. The information processing apparatus 10B may, for example, cause a display device to display an image distributed from the information processing apparatus 10A. The information processing apparatus 10B may, for example, perform an analysis based on an image distributed from the information processing apparatus 10A. When an apparatus which distributes an image performs processing such as specifying an image quality of the present disclosure, the information processing apparatus 10A is an example of the “information processing apparatus” of the present disclosure. When an apparatus to which the image is distributed performs processing such as specifying the image quality of the present disclosure, the information processing apparatus 10B is an example of the “information processing apparatus” of the present disclosure.

### First Example Embodiment

### <Processes>

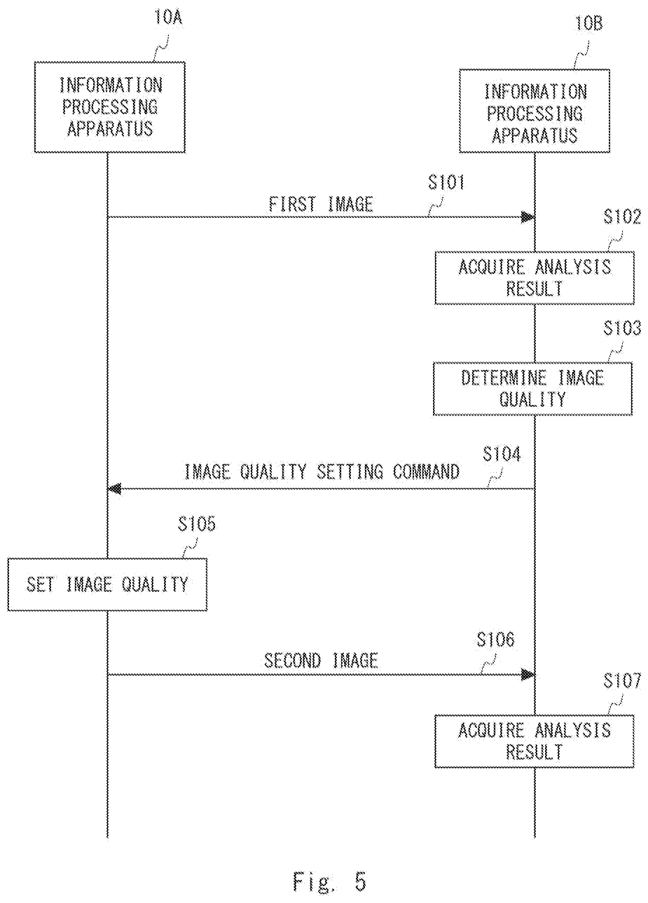

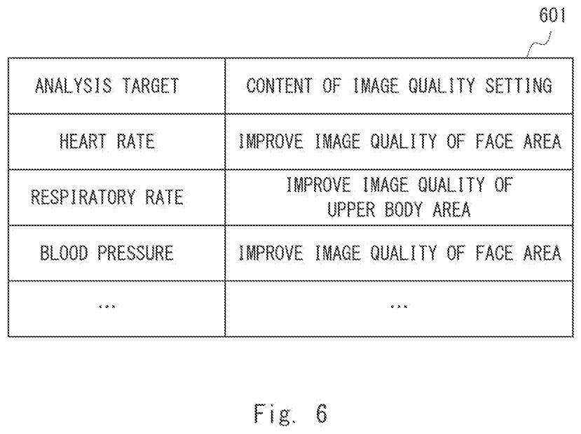

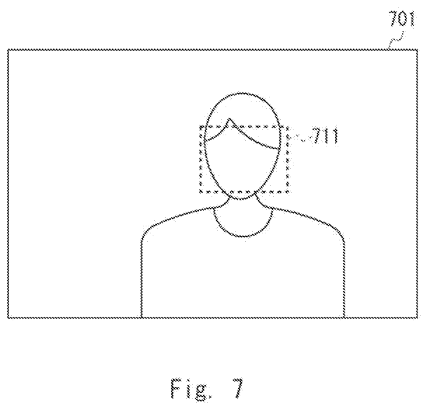

Referring next to FIGS. 5 to 7, one example of processes of the information processing system 1 according to the example embodiment will be described. FIG. 5 is a sequence diagram showing one example of the processes of the information processing system 1 according to the example embodiment. FIG. 6 is a diagram showing one example of an image quality change contents DB (database) 601 according to the example embodiment. FIG. 7 is a diagram showing one example of an area of a specific part according to the example embodiment.

Hereinafter, as one example, a case where the image quality of a specific part or the like is determined by the information processing apparatus 10B of a doctor when biological information based on a patient's image is measured in a video conference (a video call or an online medical examination) between a doctor and a patient will be described. In the following description, it is assumed that a process of establishing a video conference session or the like between the information processing apparatus 10A of the patient and the information processing apparatus 10B of the doctor has already been ended.

In Step S101, the information processing apparatus 10A distributes (transmits) the first image in which an area of a specific part of a subject in the image captured by the image-capturing apparatus 20 is coded with the first image quality to the information processing apparatus 10B via the network N.

Next, the specifying unit 12 of the information processing apparatus 10B acquires the analysis result of the information about the subject based on the area of the specific part of the subject with the first image quality in the received first image (Step S102). The specifying unit 12 of the information processing apparatus 10B may acquire the analysis result from the external apparatus (an example of “analysis means”) or may acquire the analysis result from the analysis module (an example of “analysis means”) inside the information processing apparatus 10B. Here, the analysis processing based on images (processing that estimates (calculates, infers, measures) various information about the subject) may be executed by, for example, AI (Artificial Intelligence) using deep learning. An analysis target (item of information about the subject) may include at least one of, for example, heart rate, respiratory rate, blood pressure, swelling, percutaneous arterial oxygen saturation, pupil size, throat swelling, and degree of periodontal disease. Note that the analysis target may be specified (selected or set) by a doctor or the like in advance. Further, the specifying unit 12 of the information processing apparatus 10B may determine one or more analysis targets based on results of a medical history form filled out by a patient in advance on a predetermined website or the like.

The information processing apparatus 10B may estimate a heart rate based on a video image of an area where the patient's skin is exposed (e.g., an area of face, which is an example of the “specific part”). In this case, the information processing apparatus 10B may estimate the heart rate based on, for example, transition (period) of changes in the skin color.

Further, the information processing apparatus 10B may estimate a respiratory rate based on a video image of an area of the patient's chest (upper body). In this case, the information processing apparatus 10B may estimate the respiratory rate based on, for example, a cycle of shoulder (which is an example of the “specific part”) movements.

Further, the information processing apparatus 10B may estimate blood pressure based on the video image of the area where the patient's skin is exposed (e.g., an area of face, which is an example of the “specific part”). In this case, the information processing apparatus 10B may estimate the blood pressure based on, for example, the difference between pulse waves estimated from two parts of the face (e.g., forehead and cheeks, which are an example of the “specific part”) and the shapes of these pulse waves.

Further, the information processing apparatus 10B may estimate transcutaneous arterial blood oxygen saturation (SpO2) based on the video image of the area where the patient's skin is exposed (e.g., face, which is an example of the “specific part”). Note that red is easily transmitted when hemoglobin is bonded to oxygen, while blue is insusceptible to the binding of hemoglobin to oxygen. Therefore, the information processing apparatus 10B may estimate SpO2 based on, for example, the difference in the degree of change in the blue color and red color of the skin near the cheekbones under the eyes (which is an example of the “specific part”).

Further, the information processing apparatus 10B may estimate, for example, a degree of swelling based on an image of the patient's eyelid area (which is an example of the “specific part”). Further, the information processing apparatus 10B may estimate, for example, a pupil size (pupil diameter) based on an image of the patient's eye area (which is an example of the “specific part”). Further, the information processing apparatus 10B may estimate, for example, throat swelling, a degree of periodontal disease, or the like based on an image of the patient's mouth area (which is an example of the “specific part”).

If the analysis is successful in Step S102 (e.g., when the reliability of the estimated result calculated by AI or the like is equal to or larger than a threshold), the specifying unit 12 of the information processing apparatus 10B may cause a display device to display patient's biological information (vital sign), which corresponds to the analysis results, and may not execute processing from Step S103 onward. Note that the specifying unit 12 of the information processing apparatus 10B may continuously perform an analysis and display the analysis results in real time.

On the other hand, if the analysis has failed in Step S102, the specifying unit 12 of the information processing apparatus 10B determines the image quality of the area of the specific part in the second image captured by the image-capturing apparatus 20 of the information processing apparatus 10A to be the second image quality that is higher than the first image quality (Step S103). Thus, for example, if the analysis of a certain analysis target fails, the image quality of the area of the specific part corresponding to the analysis target is improved (i.e., the resolution of the image is enhanced). Therefore, the possibility of succeeding in the subsequent analysis (reliability or accuracy of analysis results) can be improved. For example, even for images where the distance from the image-capturing apparatus 20 to the patient is relatively large, the accuracy of the analysis can be improved. In addition, by improving the image quality of only the area of the specific part, the increase in the bandwidth used for distribution can be reduced. The second image may be the same image as the first image or a different image. For example, when an image is distributed in real time, the first image is an image captured at the time of the processing in Step S101, and the second image is an image captured at a later time point than the processing in Step S104.

When the analysis result is an analysis failure due to a failure to detect a subject (e.g., a person, which is an example of the “specific part”), the specifying unit 12 of the information processing apparatus 10B may improve the image quality of the entire second image. When the analysis result is an analysis failure due to a failure to detect, for example, a subject's face (which is an example of the “specific part”), the specifying unit 12 of the information processing apparatus 10B may improve the image quality of an area of the subject in the second image. When the analysis result is an analysis failure due to a failure to detect, for example, an eye, a mouth, cheeks (which are an example of the “specific part”), the specifying unit 12 of the information processing apparatus 10B may improve the image quality of at least a part of the subject (e.g., face).

The specifying unit 12 of the information processing apparatus 10B may determine that the analysis has failed when a value of reliability of the analysis result calculated based on, for example, deep learning is equal to or smaller than a threshold. The specifying unit 12 of the information processing apparatus 10B may determine the content of the image quality change in accordance with an analysis item that has not been successfully analyzed. In this case, the specifying unit 12 of the information processing apparatus 10B may refer to, for example, the image quality change contents DB 601 and extract information about the content of the image quality change corresponding to the analysis target that has not been successfully analyzed. Note that the image quality change contents DB 601 may be stored (registered or set) in a storage apparatus inside the information processing apparatus 10B or may be stored in a DB server or the like provided in the outside of the information processing apparatus 10B. In the example of FIG. 6, the image quality change contents DB 601 stores the image quality change contents in association with the analysis target. In the example of FIG. 6, for example, when the analysis of the heart rate fails, it is defined in the image quality change contents DB 601 that the image quality of the face area is improved.

The specifying unit 12 of the information processing apparatus 10B may specify the area of the specific part, which is defined in the determined content of image quality change, in the image captured by the image-capturing apparatus 20. Here, the specifying unit 12 of the information processing apparatus 10B may determine, based on the distributed image, a rectangle (square or rectangular) area including a part such as a face by using AI or the like, and may set this rectangle area as the area of the specific part. The information indicating the area of the specific part may include, for example, coordinate positions of pixels in the lower left and the upper right of this area. Alternatively, the information indicating the area of the specific part may include, for example, information on a map (a QP map) that sets quantization parameter (QP value) for coding by a unit of a specific pixel area (e.g., 16 pixels (height)×16 pixels (width)).

Then, the specifying unit 12 of the information processing apparatus 10B may determine information indicating the image quality of the area of the specific part based on, for example, the coding scheme of the image captured by the image-capturing apparatus 20. In this case, the information indicating the image quality of the area of the specific part may include, for example, at least one of a bit rate of coding, a frame rate of coding, or a quantization parameter of coding (QP value). Note that the specifying unit 12 of the information processing apparatus 10B can improve the image quality by, for example, increasing the bit rate of coding for the second image quality than the bit rate of coding for the first image quality. Alternatively, the specifying unit 12 of the information processing apparatus 10B can improve the image quality by, for example, increasing the frame rate of coding for the second image quality than the frame rate of coding for the first image quality. The specifying unit 12 of the information processing apparatus 10B can improve the image quality by, for example, decreasing the quantization parameter (QP value) of coding for the second image quality to a value smaller than the bit rate of coding for the first image quality.

When hierarchical coding (SVC, Scalable Video Coding) is used as a coding scheme of the image captured by the image-capturing apparatus 20, the specifying unit 12 of the information processing apparatus 10B may determine to consider the entire image as a base layer and the area of the specific part as an enhancement layer. In this case, the information indicating the image quality of the area of the specific part may include a bit rate for each of one or more layers which includes at least the enhancement layer.

Further, the information indicating the image quality of the area of the specific part may include information regarding setting of the image-capturing apparatus 20. The information regarding setting of the image-capturing apparatus 20 may include a setting value regarding adjustment of the image quality of the image output from the image-capturing apparatus 20 and a setting value regarding control of the image-capturing apparatus 20. The setting regarding adjustment of the image quality of the image output from the image-capturing apparatus 20 may include, for example, at least one of bit depth (color depth), brightness, contrast, tone of color, vividness, white balance, backlight correction, and gain of the image output from the image-capturing apparatus 20. Further, the setting regarding control of the image-capturing apparatus 20 may include, for example, at least one of zoom, focus, exposure, or the like.

(Example in which image quality based on reliability of analysis result)

The specifying unit 12 of the information processing apparatus 10B may determine the second image quality of the second image based on the reliability of the analysis result from the first image. In this case, the specifying unit 12 of the information processing apparatus 10B may determine the second image quality to be higher as the reliability of the analysis result based on the first image is lower. This allows for determining the image quality that provides a predetermined level of analysis accuracy more appropriately. Alternatively, the specifying unit 12 of the information processing apparatus 10B may determine the second image quality to be a lower image quality as the reliability of the analysis result based on the first image is higher. Thus, for example, when the analysis accuracy is sufficiently high, a communication amount (bit rate) involved with the distribution of the second image can be reduced by lowering the image quality.

(Example in which increase in communication amount of second image is reduced)

The specifying unit 12 of the information processing apparatus 10B may improve the image quality of an area of a specific part (e.g., patient's face) and degrade the image quality of a part other than the specific part. Thus, for example, the increase in the communication amount of the second image can be reduced. In this case, the specifying unit 12 of the information processing apparatus 10B may, for example, determine the second image quality of the area of the specific part and determine a third image quality of the area other than the specific part to be lower than the first image quality. Then, the specifying unit 12 of the information processing apparatus 10B may transmit, to the information processing apparatus 10A, information for distributing the second image in which the area of the specific part is in the second image quality and the area other than the specific part is in the third image quality.

(Example in which image quality is determined based on bandwidth fluctuation)

The specifying unit 12 of the information processing apparatus 10B may determine the second image quality based on the fluctuation of the bandwidth available in the network N through which the image captured by the image-capturing apparatus 20 is distributed. By degrading the image quality when there is no sufficient margin for available bandwidth, the disturbance of the distributed image can be reduced. The second image quality may also be determined based on a predicted value of the available bandwidth. Accordingly, disturbance of a video image from the reduction in the bandwidth to the degradation of the image quality can be further reduced as compared to the case where, for example, the image quality is degraded after the bandwidth is reduced. In addition, the specifying unit 12 of the information processing apparatus 10B may determine the second image quality and the third image quality based on the fluctuation. Thus, for example, when there is no sufficient margin for available bandwidth if the image quality of the face area is improved, it is possible to improve the image quality of the face area and degrade the image quality of the area other than the face area, thereby reducing the disturbance of the image to be distributed.

Note that the specifying unit 12 of the information processing apparatus 10B may perform machine learning of communication log information when an image was transmitted via the network N in the past, radio quality information such as a radio wave strength, a day of the week or a time, and a relation between weather and available bandwidth in advance, and calculate available bandwidth or a predicted bandwidth value. The specifying unit 12 of the information processing apparatus 10B may determine the second image quality based on the calculated predicted value. Thus, when, for example, it is expected that there is no margin for available bandwidth if only the image quality of the face area is improved, it is possible to improve the image quality of the face area and degrade the image quality of the area other than the face area, thereby reducing the disturbance in the image to be distributed.

Next, the control unit 13 of the information processing apparatus 10B transmits information (command) for distributing the second image in which the image quality of the area of the specific part is the second image quality to the information processing apparatus 10A (Step S104). This command may include, for example, information indicating the area of the specific part and information indicating the image quality of the area of the specific part.

Next, the information processing apparatus 10A sets (changes) the image quality of the area of the specific part of the subject in the image captured by the image-capturing apparatus 20 to the second image quality based on the received command (Step S105). Next, the information processing apparatus 10A distributes (transmits) a second image whose area of the specific part of the subject in the image captured by the image-capturing apparatus 20 is coded with the second image quality to the information processing apparatus 10B via the network N (Step S106). In the example shown in FIG. 7, a face area 711 of the patient in a second image 701 is coded with the second image quality.

Next, the specifying unit 12 of the information processing apparatus 10B acquires the analysis result of the subject based on the area of the specific part of the subject in the second image quality in the received second image (Step S107). The processing in Step S107 may be the same as the processing in Step S102. If the analysis result acquired in Step S107 is information indicating that the analysis has failed, the information processing apparatus 10B may repeat the processing from Step S103 onward.

Further, when the image quality specified by the received command is not supported in the process of Step S105, the information processing apparatus 10A may send a response indicating this information back to the information processing apparatus 10B. In this case, the specifying unit 12 of the information processing apparatus 10B may cause a message indicating that the analysis has been failed to be displayed. According to this configuration, the doctor can instruct, for example, the patient to approach the image-capturing apparatus 20 by voice or other means over the phone.

(Example in which Person is Specified by Using Image of Image-Capturing Apparatus 20, which is Monitoring Camera)

In the aforementioned example, the example of measuring biological information in a video conference between a doctor and a patient has been described. In the following description, an example in which a person is specified by using an image of the image-capturing apparatus 20, which is a monitoring camera, will be described. In this case, a video image of the image-capturing apparatus 20 may be distributed from the information processing apparatus 10A to the information processing apparatus 10B.

First, when the person cannot be detected based on the image of the image-capturing apparatus 20, the specifying unit 12 of the information processing apparatus 10B may improve the image quality of the entire image. Further, when the person cannot be specified based on the image of the image-capturing apparatus 20, the specifying unit 12 of the information processing apparatus 10B may improve the image quality of the area of the specific part such as the face of the person. Further, when person's behavior cannot be specified based on the image of the image-capturing apparatus 20, the specifying unit 12 of the information processing apparatus 10B may improve the image quality of the area of the whole body of the person.

(Example in which Product is Tested (Inspected) by Image of Image-Capturing Apparatus 20)

In the following description, an example in which a product is tested (inspected) by an image of the image-capturing apparatus 20, which is a monitoring camera, will be described. In this case, a video image of the image-capturing apparatus 20 may be distributed from the information processing apparatus 10A to the information processing apparatus 10B.

First, when the product cannot be detected based on the image of the image-capturing apparatus 20, the specifying unit 12 of the information processing apparatus 10B may improve the image quality of the entire image. Further, when the product cannot be tested based on the image of the image-capturing apparatus 20, the specifying unit 12 of the information processing apparatus 10B may improve the image quality of the area of the specific part of the product.

(Example in which Facility is Checked by Using Image of Image-Capturing Apparatus 20)

In the following description, an example in which a facility is checked by using an image of an image-capturing apparatus 20 mounted on a drone, a robot that autonomously moves on the ground, or the like will be described. In this case, a video image of the image-capturing apparatus 20 may be distributed from the information processing apparatus 10A mounted on the drone or the like to the information processing apparatus 10B.

First, when an area of an object to be checked (e.g., a steel tower, an electric wire, or the like) cannot be detected based on the image of the image-capturing apparatus 20, the specifying unit 12 of the information processing apparatus 10B may improve the image quality of the entire image. Further, when a part to be checked (e.g., an insulator) cannot be tested (e.g., measurement of a damage or a degradation level) based on the image of the image-capturing apparatus 20, the specifying unit 12 of the information processing apparatus 10B may improve the image quality of the area of the specific part including a part to be checked.

### Second Example Embodiment

### <Processes>

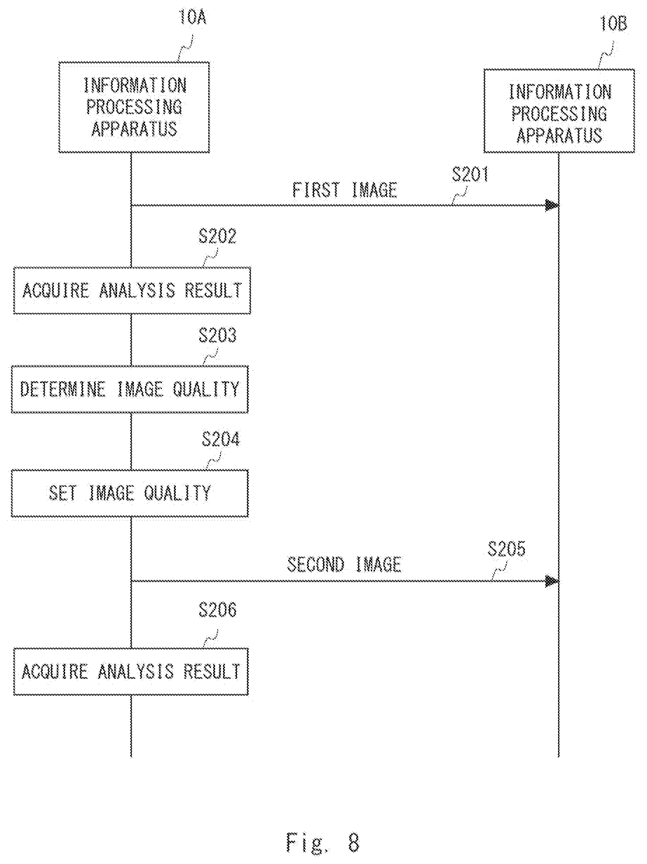

In the examples shown in FIG. 5, the example in which the image quality of a specific part or the like is determined in the information processing apparatus 10B of a doctor has been described. In the following description, an example in which the image quality of a specific part or the like is determined in the information processing apparatus 10A of a patient will be described by referring to FIG. 8. FIG. 8 is a diagram showing a configuration example of an information processing system 1 according to this example embodiment.

In Step S201, a control unit 13 of the information processing apparatus 10A distributes (transmits) a first image in which an area of a specific part of a subject in an image captured by the image-capturing apparatus 20 is coded with the first image quality to the information processing apparatus 10B via the network N. Next, the specifying unit 12 of the information processing apparatus 10A acquires the analysis result of the information about the subject based on the area of the specific part of the subject of the first image quality in the coded first image (Step S202). Here, the specifying unit 12 of the information processing apparatus 10A may acquire, for example, only information indicating the reliability of the analysis result of the information about the subject. In this case, the specifying unit 12 of the information processing apparatus 10A may predict (estimate or infer) the reliability of the analysis result of the information about the subject, for example, using AI or the like. If the analysis fails in Step S202, the specifying unit 12 of the information processing apparatus 10A determines the image quality of the area of the specific part in the second image captured by the image-capturing apparatus 20 of the information processing apparatus 10A to be a second image quality that is higher than the first image quality (Step S203).

Next, the control unit 13 of the information processing apparatus 10A sets (changes) the image quality of the area of the specific part of the subject in the image captured by the image-capturing apparatus 20 to the second image quality (Step S204). Next, the information processing apparatus 10A distributes (transmits) a second image in which the area of the specific part of the subject in the image captured by the image-capturing apparatus 20 is coded with the second image quality to the information processing apparatus 10B via the network N (Step S205).

Next, the specifying unit 12 of the information processing apparatus 10A acquires the analysis result of the subject based on the area of the specified part of the subject with the second image quality in the encoded second image (Step S206). The processes in Steps S201, S204, and S205 may be respectively similar to the processes in Steps S201, S105, and S106 FIG. 5. Further, the processes in Steps S202, S203, and S206 may be respectively similar to the processes in Steps S102, S103, and S107 in the information processing apparatus 10B in FIG. 5. Note that analysis processing similar to the processes in Steps S202 and S206 may be executed in parallel in the information processing apparatus 10B as well.

### Modified Examples

While the information processing apparatus 10 may be an apparatus included in one housing, the information processing apparatus 10 according to the present disclosure is not limited to this example. Each unit of the information processing apparatus 10 may be implemented, for example, by cloud computing constituted by one or more computers. Further, at least a part of the processes of the information processing apparatus 10 may be implemented, for example, by another information processing apparatus 10. Such an information processing apparatus 10 is also included in one example of the “information processing apparatus” according to the present disclosure.

Note that the present disclosure is not limited to the aforementioned example embodiments and may be changed as appropriate without departing from the spirit of the present disclosure.

The whole or part of the example embodiments disclosed above can be described as, but not limited to, the following supplementary notes.

### (Supplementary Note 1)

An information processing system comprising:
specifying means for specifying, in accordance with an analysis result based on a coded and distributed image, an image quality of an area including a specific part in the distributed image; and
control means for performing control for distributing the image in which the image quality of the area including the specific part is the specified image quality.
   (Supplementary note 2)

The information processing system according to supplementary note 1, wherein the specifying means specifies the image quality in accordance with reliability of the analysis result.

(Supplementary note 3)

The information processing system according to supplementary note 1 or 2, wherein
the specifying means specifies the image quality for the entire image when a subject cannot be detected based on the distributed image,
the specifying means specifies the image quality of an area of the subject when the specific part of the subject cannot be detected based on the distributed image, and
the specifying means specifies the image quality of the area of the specific part when an analysis based on the area of the specific part of the distributed image cannot be performed.
   (Supplementary note 4)

The information processing system according to any one of supplementary notes 1 to 3, wherein when the reliability of the analysis result is equal to or smaller than a threshold, the specifying means causes analysis means to perform an analysis based on the image in the image quality.

(Supplementary note 5)

The information processing system according to any one of supplementary notes 1 to 4, wherein the specifying means specifies the image quality based on a bandwidth available in a network through which the image is distributed.

(Supplementary note 6)

The information processing system according to any one of supplementary notes 1 to 5, wherein the specifying means improves the image quality of the area of the specific part and degrades the image quality of an area other than the specific part when the analysis based on the area of the specific part cannot be performed.

(Supplementary note 7)

The information processing system according to any one of supplementary notes 1 to 6, wherein the image quality includes an image quality based on at least one of a bit rate of coding, a frame rate of the coding, a quantization parameter of the coding, an area and a bit rate setting of each layer in hierarchical coding, and a setting of an image-capturing apparatus for capturing the image.

(Supplementary note 8)

An information processing method comprising:
processing for specifying, in accordance with an analysis result based on a coded and distributed image, an image quality of an area including a specific part in the distributed image; and
processing performing control for distributing the image in which the image quality of the area including the specific part is the specified image quality.
   (Supplementary note 9)

The information processing method according to supplementary notes 8, wherein, in the specifying processing, the image quality is specified in accordance with reliability of the analysis result.

(Supplementary note 10)

The information processing method according to supplementary notes 8 or 9, wherein
in the specifying processing, the image quality is specified for the entire image when a subject cannot be detected based on the distributed image,
the image quality is specified for the area of the subject when the specific part of the subject cannot be detected based on the distributed image, and
the image quality is specified for the area of the specific part when an analysis based on the area of the specific part of the distributed image cannot be performed.
   (Supplementary note 11)

The information processing method according to any one of supplementary notes 8 to 10, wherein in the specifying processing, when the reliability of the analysis result is equal to or smaller than a threshold, analysis means is caused to perform an analysis based on the image in the image quality.

(Supplementary note 12)

The information processing method according to any one of supplementary notes 8 to 11, wherein in the specifying processing, the image quality is specified based on a bandwidth available in a network through which the image is distributed.

(Supplementary note 13)

The information processing method according to any one of supplementary notes 8 to 12, wherein in the specifying processing, the image quality of the area of the specific part is improved and the image quality of an area other than the specific part is degraded when the analysis based on the area of the specific part cannot be performed.

(Supplementary note 14)

The information processing method according to any one of supplementary notes 8 to 13, wherein the image quality includes an image quality based on at least one of a bit rate of coding, a frame rate of the coding, a quantization parameter of the coding, an area and a bit rate setting of each layer in hierarchical coding, and a setting of an image-capturing apparatus for capturing the image.

(Supplementary note 15)

An information processing apparatus comprising:
specifying means for specifying, in accordance with an analysis result based on a coded and distributed image, an image quality of an area including a specific part in the distributed image; and
control means for performing control for distributing the image in which the image quality of the area including the specific part is the specified image quality.
   (Supplementary note 16)

The information processing apparatus according to Supplementary note 15, wherein the specifying means specifies the image quality in accordance with reliability of the analysis result.

(Supplementary note 17)

The information processing apparatus according to supplementary note 15 or 16, wherein
the specifying means specifies the image quality for the entire image when a subject cannot be detected based on the distributed image,
the specifying means specifies the image quality of an area of the subject when the specific part of the subject cannot be detected based on the distributed image, and
the specifying means specifies the image quality of the area of the specific part when an analysis based on the area of the specific part of the distributed image cannot be performed.
   (Supplementary note 18)

The information processing apparatus according to any one of supplementary notes 15 to 17, wherein when the reliability of the analysis result is equal to or smaller than a threshold, the specifying means causes analysis means to perform an analysis based on the image in the image quality.

(Supplementary note 19)

The information processing apparatus according to any one of supplementary notes 15 to 18, wherein the specifying means specifies the image quality based on a bandwidth available in a network through which the image is distributed.

(Supplementary note 20)

The information processing apparatus according to any one of supplementary notes 15 to 19, wherein the specifying means improves the image quality of the area of the specific part and degrades the image quality of an area other than the specific part when the analysis based on the area of the specific part cannot be performed.

(Supplementary note 21)

The information processing apparatus according to any one of supplementary notes 15 to 20, wherein the image quality includes an image quality based on at least one of a bit rate of coding, a frame rate of the coding, a quantization parameter of the coding, an area and a bit rate setting of each layer in hierarchical coding, and a setting of an image-capturing apparatus for capturing the image.

### REFERENCE SIGNS LIST

1 INFORMATION PROCESSING SYSTEM
10 INFORMATION PROCESSING APPARATUS
10A INFORMATION PROCESSING APPARATUS
10B INFORMATION PROCESSING APPARATUS
12 SPECIFYING UNIT
13 CONTROL UNIT
20 IMAGE-CAPTURING APPARATUS
N NETWORK

What is claimed is:

1. An information processing system comprising:
at least one memory storing instructions, and
at least one processor configured to execute the instructions to;
specify, in accordance with an analysis result based on a coded and distributed image, an image quality of an area including a specific part in the distributed image; and
perform control for distributing the image in which the image quality of the area including the specific part is the specified image quality.

2. The information processing system according to claim 1, wherein the at least one processor is configured to specify the image quality in accordance with reliability of the analysis result.

3. The information processing system according to claim 1, wherein
the at least one processor is configured to specify the image quality for the entire image when a subject cannot be detected based on the distributed image,
the at least one processor is configured to specify the image quality of an area of the subject when the specific part of the subject cannot be detected based on the distributed image, and
the at least one processor is configured to specify the image quality of the area of the specific part when an analysis based on the area of the specific part of the distributed image cannot be performed.

4. The information processing system according to claim 1, wherein when the reliability of the analysis result is equal to or smaller than a threshold, the at least one processor is configured to perform an analysis based on the image in the image quality.

5. The information processing system according to claim 1, wherein the at least one processor is configured to specify the image quality based on a bandwidth available in a network through which the image is distributed.

6. The information processing system according to claim 1, wherein the at least one processor is configured to improve the image quality of the area of the specific part and degrades the image quality of an area other than the specific part when the analysis based on the area of the specific part cannot be performed.

7. The information processing system according to claim 1, wherein the image quality includes an image quality based on at least one of a bit rate of coding, a frame rate of the coding, a quantization parameter of the coding, an area and a bit rate setting of each layer in hierarchical coding, and a setting of an image-capturing apparatus for capturing the image.

8. An information processing method comprising:
processing for specifying, in accordance with an analysis result based on a coded and distributed image, an image quality of an area including a specific part in the distributed image; and
processing performing control for distributing the image in which the image quality of the area including the specific part is the specified image quality.

9. The information processing method according to claim 8, wherein, in the specifying processing, the image quality is specified in accordance with reliability of the analysis result.

10. The information processing method according to claim 8, wherein
in the specifying processing, the image quality is specified for the entire image when a subject cannot be detected based on the distributed image,
the image quality is specified for the area of the subject when the specific part of the subject cannot be detected based on the distributed image, and
the image quality is specified for the area of the specific part when an analysis based on the area of the specific part of the distributed image cannot be performed.

11. The information processing method according to claim 8, wherein in the specifying processing, when the reliability of the analysis result is equal to or smaller than a threshold, performs an analysis based on the image in the image quality.

12. The information processing method according to claim 8, wherein in the specifying processing, the image quality is specified based on a bandwidth available in a network through which the image is distributed.

13. The information processing method according to claim 8, wherein in the specifying processing, the image quality of the area of the specific part is improved and the image quality of an area other than the specific part is degraded when the analysis based on the area of the specific part cannot be performed.

14. The information processing method according to claim 8, wherein the image quality includes an image quality based on at least one of a bit rate of coding, a frame rate of the coding, a quantization parameter of the coding, an area and a bit rate setting of each layer in hierarchical coding, and a setting of an image-capturing apparatus for capturing the image.

15. An information processing apparatus comprising:
at least one memory storing instructions, and
at least one processor configured to execute the instructions to;
specify, in accordance with an analysis result based on a coded and distributed image, an image quality of an area including a specific part in the distributed image; and
perform control for distributing the image in which the image quality of the area including the specific part is the specified image quality.

16. The information processing apparatus according to claim 15, wherein the at least one processor is configured to specify the image quality in accordance with reliability of the analysis result.

17. The information processing apparatus according to claim 15, wherein
the at least one processor is configured to specify the image quality for the entire image when a subject cannot be detected based on the distributed image,
the at least one processor is configured to specify the image quality of an area of the subject when the specific part of the subject cannot be detected based on the distributed image, and
the at least one processor is configured to specify the image quality of the area of the specific part when an analysis based on the area of the specific part of the distributed image cannot be performed.

18. The information processing apparatus according to claim 15, wherein when the reliability of the analysis result is equal to or smaller than a threshold, the at least one processor is configured to perform an analysis based on the image in the image quality.

19. The information processing apparatus according to claim 15, wherein the at least one processor is configured to specify the image quality based on a bandwidth available in a network through which the image is distributed.

20. The information processing apparatus according to claim 15, wherein the at least one processor is configured to improve the image quality of the area of the specific part and degrades the image quality of an area other than the specific part when the analysis based on the area of the specific part cannot be performed.

21. (canceled)
